(19) United States
(12) Patent Application Publication
(10) Pub. No.: US 2025/0047045 A1
(43) Pub. Date: Feb. 6, 2025

(54) Connector With Removable Ingress Protection Element

(71) Applicant: HARTING Electric Stiftung & Co. KG, Espelkamp (DE)

(72) Inventors: Karol GOSZCZYNSKI, Big Rock, IL (US); Jeffrey PAWLICKI, Plainfield, IL (US)

(73) Assignee: HARTING Electric Stiftung & Co. KG, Espelkamp (DE)

(21) Appl. No.: 18/793,836

(22) Filed: Aug. 4, 2024

Related U.S. Application Data
(60) Provisional application No. 63/530,958, filed on Aug. 5, 2023.

(51) Int. Cl. H01R 24/20; H01R 13/04; H01R 13/52

(52) U.S. Cl. CPC H01R 24/20; H01R 13/04; H01R 13/52

(57) ABSTRACT

An electrical plug connector (100) may include a plug insert (130), and a pin contact (150) arranged within the plug insert (130). The electrical plug connector is IP20 “Finger Safe.” Finger safety is achieved by a contact tip insulator (160) that may be fastened to a front end of the pin contact (150) and a removable ingress protection frame (170) comprising ingress barriers (176) arranged between a side wall (132) of the plug insert (130) and the pin contact (150).

### TECHNICAL FIELD

The present disclosure relates to electrical connectors, and more specifically to industrial plug connectors having an IP20 rating on their plug-in side.

### BACKGROUND

Plug and socket connectors are usually made up of a male plug and a female socket. The plug typically includes pin contacts, and the socket typically includes receptacle contacts. Sockets are often permanently fixed to a device as in a chassis connector, and plugs are attached to a cable. Plugs and sockets may be connected to cables, for example, to connect two cables to one another.

Plugs generally have one or more metal contacts, also referred to as terminals, which are inserted into openings in the mating socket. The connection between the mating metal parts must be sufficiently tight to make a good electrical connection and complete a circuit.

IEC 60529 has been developed to rate and grade the resistance of enclosures of electric and electronic devices against the intrusion of dust and liquids. It also rates how easy it is for individuals to access the potentially hazardous parts within the enclosure.

Within the IEC 60529 rating system, IP20 is often referred to as the “Finger-Safe” rating for electrical components. It refers to the fact that a probe, the approximate size of a finger, must not be able to access or make contact with hazardous, energized parts. Live parts that could easily be touched while resetting, adjusting, or replacing nearby components must be provided with protection against direct contact with at least the IP20 rating.

### SUMMARY

Traditionally, the plug-in side of plug connectors does not comply with IP20 “Finger Safe” requirements. Rather, electrical socket connectors are designed to be finger safe, and plug connectors are intended to not contain any energized pin contacts when disconnected from their mating socket. Therefore, finger safety is generally not required for plug connectors.

In some applications, it may be desirable for an electrical plug connector to meet IP20 “Finger Safe” requirements. This may allow pin contacts to be energized even if the plug connector is disconnected from its mating socket. This could be caused, for example, by a residual charge of a capacitor that is electrically connected to the pin contacts of the plug connector.

An IP20-rated electrical plug connector includes a plug insert. A pin contact is arranged within the plug insert. A contact tip insulator is fastened to a front end of the pin contact. A plurality of contact holding arms extend from a side wall of the plug insert towards the pin contact for securing the pin contact in the plug insert. A removable ingress protection frame includes ingress barriers arranged between the side wall and the pin contact in front of the contact holding arms.

An ingress opening between the side wall and the contact tip insulator is wider than 12 mm when the ingress protection frame is removed from the connector for service. Without the contact tip insulator and the ingress protection frame the plug connector is not finger safe. When the contact tip insulator and the ingress protection frame are installed, a remaining ingress opening between the side wall and the contact tip insulator is narrower than 12 mm and the plug connector is then finger safe.

The ingress protection frame may include a base plate. The base plate may include a central contact opening. A plurality of retention arms may extend forwardly from the base plate. The retention arms may each include a chamfered protrusion extending outwardly near a front end thereof. The retention arms, with their chamfered protrusions, may form a clip-connection with window openings of the plug insert. The ingress barriers may extend forwardly from the base plate in between the retention arms. The ingress barriers may be generally cuboid.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 shows an exploded view of a plug and socket connection system.

FIG. 2 shows a plug housing and an alike socket housing configured to be connected to a respective cable.

FIG. 3 shows an example of a plug insert.

FIG. 4 is a cross-sectional view IV-IV of the plug insert shown in FIG. 3.

FIG. 5 is a cross-sectional view V-V of the plug insert shown in FIG. 3.

FIG. 6 is a perspective rear view of an ingress protection frame.

FIG. 7 is a perspective front view of the ingress protection frame as in FIG. 6.

### DETAILED DESCRIPTION

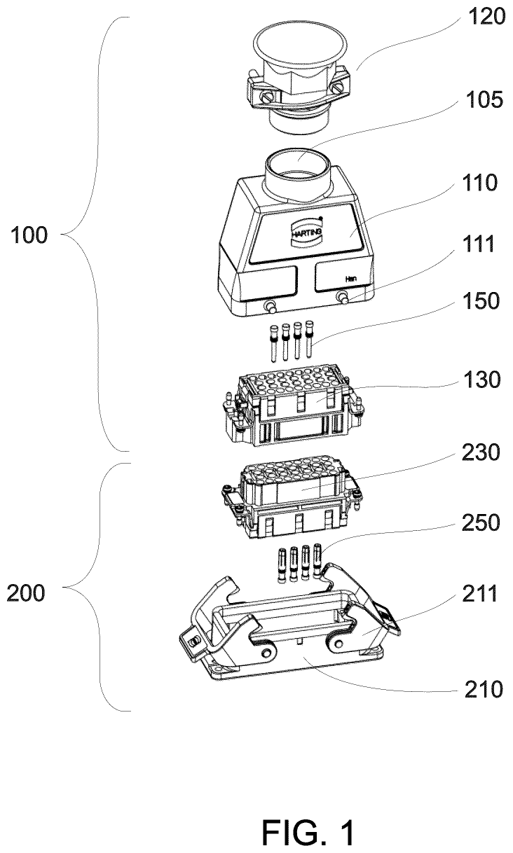

FIG. 1 shows an exploded view of a plug and socket connection system. The system includes a plug connector 100 and a socket connector 200.

The plug connector 100 includes a plurality of pin contacts 150. The pin contacts 150 are sometimes referred to as male contacts. In the context of the present application, they should be more broadly understood to refer to a first type of contacts. When in use, each of the pin contacts 150 is electrically connected to one wire of a cable. The pin contacts 150 may be in the form of screw terminals, crimp terminals, or cage-clamp terminals. The terms contact and terminal are used interchangeably. The pin contacts 150 are securely held within a plug insert 130. The plug insert 130 is in turn secured within a plug housing 110. The plug housing 110 may also be referred to as a hood. The plug housing 110 includes a cable entry opening 105, which can be arranged for a rear entry or a side entry of the cable. A cable entry protection 120 may be secured to the cable entry opening 105. The cable entry protection 120 can come in various configurations. The cable entry protection 120 can for example be a universal cable gland, a special cable clamp with strain relief, a bell-mouthed cable fitting, or an anti-twist device. A cable gland may include one or multiple seals.

The plug connector 100 is configured to mate with a corresponding socket connector 200. The socket connector 200 includes a plurality of receptacle contacts 250. Receptacle contacts are sometimes referred to as female contacts. In the context of the present application, they should be more broadly understood to refer to a second type of contacts. Each of the receptacle contacts 250 is configured to receive one of the pin contacts 150 to create an electrical connection. The receptacle contacts 250 are securely held within a socket insert 230. The socket insert 230 is secured within a socket housing 210.

The geometries of the plug insert 130 and the socket insert 230 are coordinated such that they can be plugged together. When being plugged together, portions of the plug insert 130 and the socket insert 230 overlap.

A locking mechanism may be provided to lock the plug connector 100 to the socket connector 200. The locking mechanism may include a lever 211 that is pivotally connected to the socket housing 210. The lever 211 may include a recess that engages a locking protrusion 111 of the plug housing 110. When engaged, the lever 211 securely holds the plug connector 100 and the socket connector 200 together. The lever 211 can be pivoted into an unlocked position to disengage the locking protrusion 111 for removing the plug connector 100 from the socket connector 200.

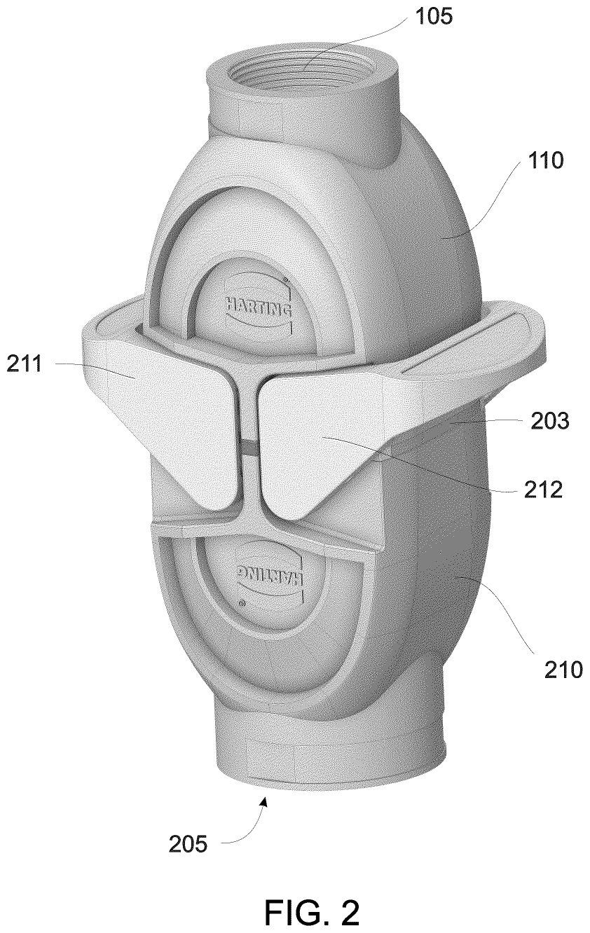

FIG. 1 illustrates an example in which the socket connector 200 is suitable to be permanently fixed to a device as in a chassis connector. FIG. 2 shows an alternative configuration in which the plug housing 110 and the socket housing 210 are alike and both are configured to be connected to a respective cable. Both the plug housing 110 and the socket housing 210 include respective cable entry openings 105, 205. The plug housing 110 is locked to the socket housing 210 by a locking mechanism. The locking mechanism here includes two levers 211, 212. The levers 211, 212 are shown in the locked state. To unlock the plug housing 110 from the socket housing 210 the levers can be pivoted towards the socket connector 200. A seal 203 is arranged between the plug housing 110 and the socket housing 210.

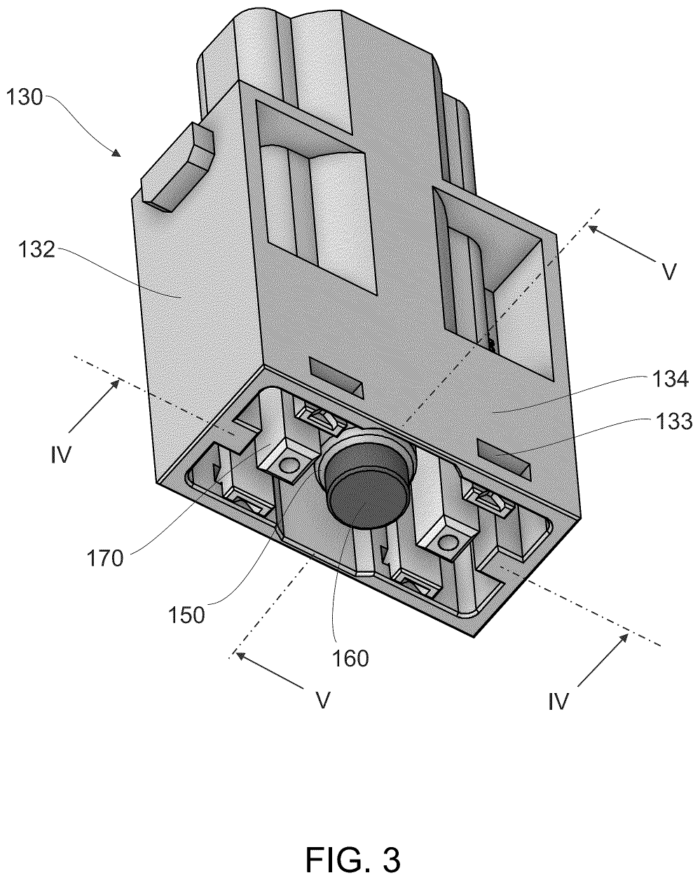

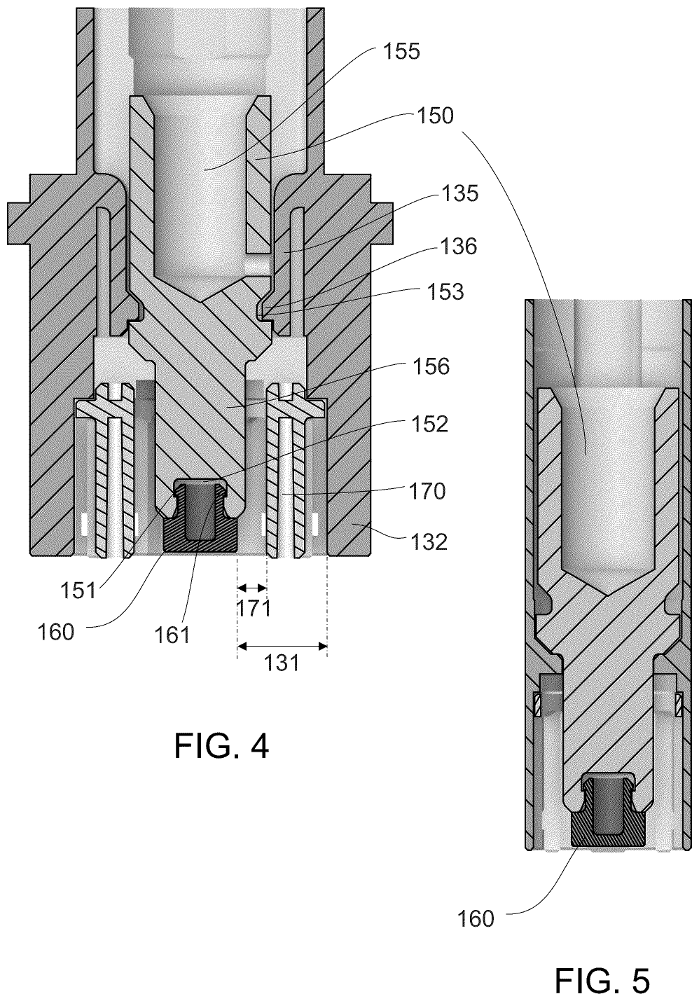

FIG. 3 shows an example of a plug insert 130 that is suitable to be used in combination with the plug housing 110 shown in FIG. 1 or 2. FIG. 4 is a cross-sectional view IV-IV of the plug insert 130 shown in FIG. 3. FIG. 5 is a cross-sectional view V-V of the plug insert 130 shown in FIG. 3. Two or more plug inserts 130 may be arranged adjacent to one another and fixed in the plug housing 110.

A single pin contact 150 is fixedly held within the plug insert 130. The pin contact 150 may be capable of conducting currents up to 100 A. The pin contact 150 includes an annular groove 153 between a crimp section 155 and a mating section 156 of the pin contact 150. The annular groove 153 is axially arranged approximately half way between a front end and a rear end of the pin contact 150. Forwardly bent contact holding arms 135 extend on an inside from the narrow side wall 132. “Forwardly” here refers to an orientation from a wire-connection side towards a plug-in side of the connector. The forwardly bent contact holding arms 135 include inwardly directed chamfered protrusions 136 which engage the annular groove 153. The pin contact 150 is so secured to the plug insert 130 by the forwardly bent contact holding arms 135.

The pin contact 150 could normally be reached by an object with a size of less than 12 mm, for example, a human finger. An ingress opening 131 in front of the forwardly bent contact holding arms 135 must be sufficiently wide to access the contact holding arms 135 in order to release and remove the pin contact 150 for service.

As shown in FIG. 4, the metal portion of the pin contact 150 is IP20 compliant and cannot be reached by small objects having a minimum extension of less than 12 mm. Ingress protection is achieved by a contact tip insulator 160 and an ingress protection frame 170.

The contact tip insulator 160 has a hollow cylindrical body that is plugged into a tip of the pin contact 150. The contact tip insulator 160 so forms a forward extension of the pin contact 150 on its plug-in side. At its rear end, the contact tip insulator 160 comprises an annular chamfered protrusion 161. The annular chamfered protrusion 161 engages an undercut annular groove 152 formed within a hollow tip 152 of the pin contact 150. The contact tip insulator 160 is made of a resiliently deformable electrically insulating material, for example, rubber.

The ingress opening 131 spans between the tip of the pin contact 150 and a narrow side wall 132 of the plug insert 130. The ingress opening 131 in the illustrated example is larger than 12 mm, which would allow a finger to reach the pin contact 150 and be incompatible with an IP20 rating. The ingress protection frame 170 is therefore arranged between the narrow side wall 132 of the plug insert 130 and the pin contact 150. A remaining ingress opening 171 between the ingress protection frame 170 and the pin contact 150 is narrower than 12 mm, and the connector is now finger safe and IP20 rated.

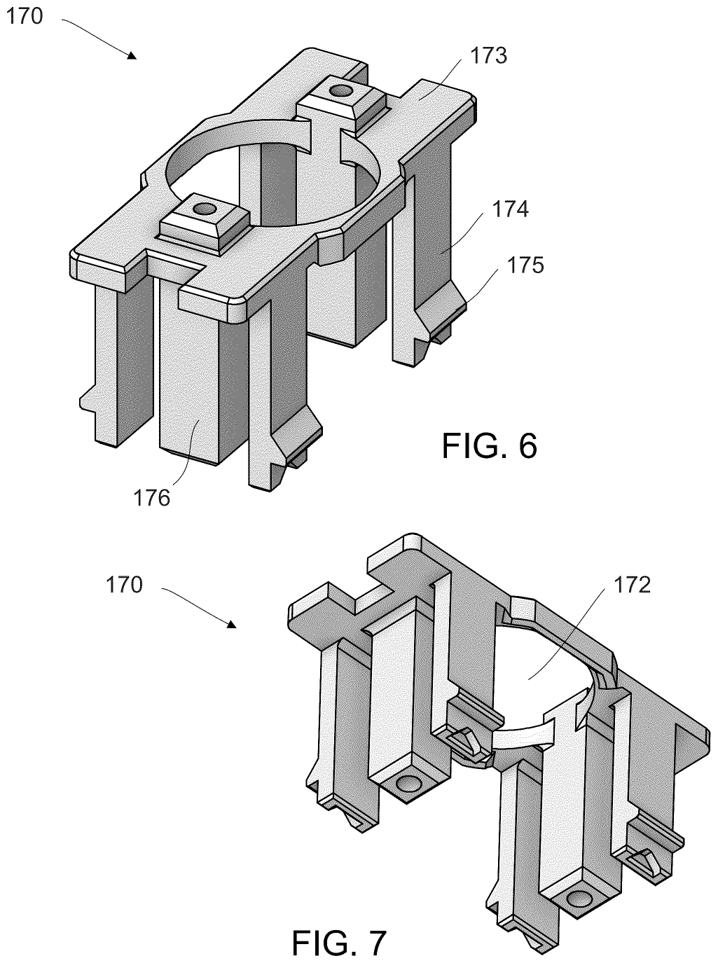

FIG. 6 is a perspective rear view of the ingress protection frame 170. FIG. 7 is a perspective front view thereof. The ingress protection frame 170 has a generally rectangular base plate 173 arranged at its rear end. A central contact opening 172 extends through the base plate 173. The pin contact 150 extends through the central contact opening 172 when the ingress protection frame 170 is inserted into the plug insert 130.

Four retention arms 174 extend forwardly from the base plate 173. One of the four retention arms 174 each is arranged proximal to each corner of the base plate 173. A chamfered protrusion 175 extends outwardly near a front end of each of the four retention arms 174. The chamfered protrusions 175 engage window openings 133 formed in wide side walls 134 of the plug insert 130. The four retention arms 174, with their chamfered protrusions 175, so form a clip-connection with the window openings 133 of the plug insert 130. The clip-connection between the ingress protection frame 170 and the plug insert 130 is releasable, and the ingress protection frame 170 is a removable ingress protection element.

Two generally cuboid ingress barriers 176 extend forwardly from the base plate 173. The two generally cuboid ingress barriers 176 extend parallel and adjacent to the pin contact 150. Front ends of the two generally cuboid ingress barriers 176 are in a common plane with a front end of the contact tip insulator 160 and the side walls 132, 134 of the plug insert 130. The two generally cuboid ingress barriers 176 are arranged on opposite sides of the pin contact 150 between the pin contact 150 and the narrow side walls 132.

The ingress protection frame 170 is an optional component that may be used in combination with the plug insert 130 when IP20 finger safety is required. In that case, the ingress protection frame 170 can be clipped into the plug insert 130 from a plug-in side. The plug insert 130 can alternatively be used without the ingress protection frame 170 when IP20 finger safety is not required. The ingress protection frame 170 does not contribute to the structural integrity of the plug insert 130. Usability of the plug connector 100 for establishing electrical connections is not affected by the presence or absence of the ingress protection frame 170.

The use of an ingress protection frame 170 allows retrofitting existing plug connectors 100 that have not originally been designed for finger safety. This includes modular plug connectors which comprise a plurality of plug connector modules installed in a holding frame. Such an arrangement is taught in U.S. Pat. No. 6,004,162, the contents of which is incorporated by reference in its entirety.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. An electrical plug connector (100), comprising:
a plug insert (130);
a pin contact (150) arranged within the plug insert (130);
a contact tip insulator (160) fastened to a front end of the pin contact (150);
a plurality of contact holding arms (135) extending from a side wall (132) of the plug insert (130) towards the pin contact (150) for securing the pin contact (150) in the plug insert (130); and
a removable ingress protection frame (170) comprising ingress barriers (176) arranged between the side wall (132) and the pin contact (150) in front of the contact holding arms (135).

2. The electrical plug connector (100) as in claim 1,
wherein an ingress opening (131) between the side wall (132) and the contact tip insulator (160) is wider than 12 mm when the removable ingress protection frame (170) is removed from the connector for service, and
wherein a remaining ingress opening (171) between the side wall (132) and the contact tip insulator (160) is narrower than 12 mm when the removable ingress protection frame (170) is installed in the connector (100).

3. The electrical plug connector (100) as in claim 1,
wherein the removable ingress protection frame (170) comprises
a base plate (173), and
a plurality of retention arms (174) which extend forwardly from the base plate (173), and
wherein the retention arms (174) each comprise a chamfered protrusion (175) extending outwardly near a front end thereof, and
wherein the retention arms (174), with their chamfered protrusions (175), form a clip-connection with window openings (133) of the plug insert (130).

4. The electrical plug connector (100) as in claim 3,
wherein the ingress barriers (176) extend forwardly from the base plate (173).

5. The electrical plug connector (100) as in claim 3,
wherein the base plate (173) comprises a central contact opening (172).

6. The electrical plug connector (100) as in claim 1,
wherein the ingress barriers (176) are generally cuboid.

7. The electrical plug connector (100) as in claim 1,
wherein the pin contact (150) includes an annular groove (153) between a crimp section (155) and a mating section (156) of the pin contact (150).

8. The electrical plug connector (100) as in claim 7,
wherein the annular groove (153) is axially arranged approximately half way between the front end and a rear end of the pin contact (150).

9. The electrical plug connector (100) as in claim 7,
wherein the contact holding arms (135) include inwardly directed chamfered protrusions (136) to engage the annular groove (153).

10. The electrical plug connector (100) as in claim 1,
wherein the pin contact (150) is secured to the plug insert (130) by the contact holding arms (135).

11. The electrical plug connector (100) as in claim 1,
wherein the contact tip insulator (160) includes a hollow cylindrical body, plugged into a tip of the pin contact (150).

12. The electrical plug connector (100) as in claim 1,
wherein the ingress barriers (176) extend parallel and adjacent to the pin contact (150).

13. The electrical plug connector (100) as in claim 1,
wherein the plug insert (130) is one of a plurality of plug connector modules arranged in a module holding frame.
